(19) United States
(12) Patent Application Publication
(10) Pub. No.: US 2006/0205894 A1
(43) Pub. Date: Sep. 14, 2006

(54) High flow misible polycarbonate polyester composition

(75) Inventors: Abbas Alli Ghudubhai Shaikh, Bangalore (IN); Ganesh Kannan, Bangalore, Karnataka (IN); Vishvajit Juikar, Bangalore, Karnataka (IN)

Correspondence Address: Marina Larson & Associates, LLC, P.O. BOX 4928, DILLON, CO, 80435, US

(73) Assignee: General Electric Company, Schenectady, NY (US)

(21) Appl. No.: 11/278,493

(22) Filed: Apr. 3, 2006

Related U.S. Application Data
(63) Continuation of application No. 10/814,947, filed on Mar. 31, 2004, now abandoned.
(60) Provisional application No. 60/524,787, filed on Nov. 25, 2003.

(51) Int. Cl. C08F 20/00

(52) U.S. Cl. 525/437; 525/439

(57) ABSTRACT

A high flow miscible thermoplastic resin composition is disclosed which comprises structural units derived from substituted or unsubstituted polycarbonate and substituted or unsubstituted aliphatic polyester. Also disclosed is a high flow and miscible thermoplastic resin composition that comprises of structural units derived from substituted or unsubstituted polycarbonate and substituted or unsubstituted low molecular weight aliphatic polyester. In addition the composition disclosed possess good optical and thermal properties and good flow.

### CROSS REFERENCE TO RELATED APPLICATIONS

This application claims priority to U.S. Provisional Application Serial No. 60/524787 filed on Nov. 25, 2003, which is incorporated herein by reference in its entirety.

### BACKGROUND OF THE INVENTION

This invention relates to a stabilized thermoplastic resin composition, a method to synthesize the composition and articles made from the compositions.

Polycarbonate is a useful engineering plastic for parts requiring clarity, high toughness, and, in some cases, good heat resistance. However, polycarbonate also has some important deficiencies, among them poor chemical and stress crack resistance, poor resistance to sterilization by gamma radiation, and poor processability. Blends polyesters with polycarbonates provide thermoplastic compositions having improved properties over those based upon either of the single resins alone. Moreover, such blends are often more cost effective than polycarbonate alone. Moldable crystalline resin compositions such as polycarbonate-polyester blends are desirable for many applications. On exposure to high temperature and humidity, such blends may exhibit relatively poor hydrolytic stability. Another problem associated with these blends is due to ester-carbonate interchange, also known as trans esterification, which may lead to loss of mechanical properties. Also, another weak area of polycarbonate is that it has a high melt viscosity which makes it difficult to mold. Medium to high flow polycarbonate grades suffer from the fact that the low temperature ductility is sacrificed for a better flow.

U.S. Pat. No. 4,188,314, U.S. Pat. No. 4,125,572; U.S. Pat. No. 4,391,954; U.S. Pat. No. 4,786,692; U.S. Pat. No. 4,897,453, and 5,478,896 relate to blends of an aromatic polycarbonate and poly cyclohexane dimethanol phthalate. U.S. Pat. No. 4,125,572 relates to a blend of polycarbonate, polybutylene terephthalate (PBT) and an aliphatic/cycloaliphatic iso/terephthalate resin. U.S. Pat. No. 6,281,299 discloses a process for manufacturing transparent polyester/polycarbonate compositions, wherein the polyester is fed into the reactor after bisphenol A is polymerized to a polycarbonate. U.S. Pat. No. 4,188,314 to Fox describes the addition of a polyester polymer derived from a cyclohexanedimethanol and a mixture of iso- and terephthalic acid to an aromatic carbonate polymer to enhance the solvent resistance as compared to a polycarbonate article.

The U.S. patent application Ser. No. 2002/0111428 deals with a material that has an unique property profile in terms of transparency, low temperature ductility at −20 to −40° C. containing special-effect colorants.

U.S. Pat. No. 5,859,119 relates to molding compositions with desirable ductility and melt properties. The composition contains a cyclo aliphatic polyester resin, an impact modifying resin which increases the ductility of the polyester but reduces the flow properties. The composition also contains a filler and a polyetherester which increase flow without reduction in ductility to give opaque blends.

Transparent blends of polycarbonate and polyesters typically have attractive properties like toughness and chemical resistance. It is desirable to form blends of this type that can be processed at low temperatures while retaining desirable properties, especially toughness. There is a continuing need for polycarbonate polyester blends having a good balance of optical property, processability, good flow, solvent resistance and hydrostability in addition to good mechanical and thermal properties.

There is a continuing need for polycarbonate polyester blends having a good balance of transparency, processability, solvent resistance and environmental stress cracking resistance in addition to good mechanical and thermal properties.

### BRIEF DESCRIPTION OF THE INVENTION

The present inventors have unexpectedly discovered a high flow and miscible thermoplastic resin composition comprising: structural units derived from substituted or unsubstituted polycarbonate and substituted or unsubstituted aliphatic polyester. In one embodiment the present invention relates to a high flow and miscible thermoplastic resin composition comprising: structural units derived from substituted or unsubstituted polycarbonate and substituted or unsubstituted low molecular weight aliphatic polyester.

Also disclosed is a synthesis method for the thermoplastic resin compositions of the present invention and articles derived from said composition. In one embodiment of the present invention the stabilized composition of the present invention has improved properties.

Various other features, aspects, and advantages of the present invention will become more apparent with reference to the following description, examples, and appended claims.

### DETAILED DESCRIPTION OF THE INVENTION

The present invention may be understood more readily by reference to the following detailed description of preferred embodiments of the invention and the examples included herein. In this specification and in the claims, which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term “polycarbonate” refers to polycarbonates incorporating structural units derived from one or more dihydroxy aromatic compounds and includes copolycarbonates and polyester.

As used herein the term “PCCD” is defined as poly(cyclohexane-1,4- dimethylene cyclohexane-1,4-dicarboxylate).

As used herein the term “CHDM” is defined as 1,4-cyclohexanedimethanol (trans/cis mixture)

As used herein the term “t-DMCD” is defined as dimethyl trans-1,4-cyclohexanedicarboxylate.

A component of the thermoplastic composition of the invention is an aliphatic or an aromatic polycarbonate. The aromatic polycarbonate resins suitable for use in the present invention, methods of making polycarbonate resins and the use of polycarbonate resins in thermoplastic molding compounds are well known in the art, see, generally, U.S. Pat. Nos. 3,169,121, 4,487,896 and 5,411,999, the respective disclosures of which are each incorporated herein by reference.

Polycarbonates useful in the invention comprise repeating units of the formula (I) 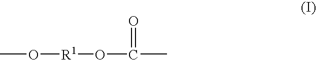
wherein R¹ is a divalent aliphatic aromatic or aromatic radical or mixture of both derived from a dihydroxyaromatic compound of the formula HO—D—OH, wherein D has the structure of formula: 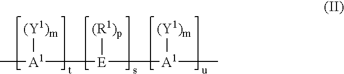
wherein A¹ represents an aliphatic or an aromatic group including, but not limited to, phenylene, biphenylene, naphthylene, and the like. In some embodiments E may be an alkylene or alkylidene group including, but not limited to, methylene, ethylene, ethylidene, propylene, propylidene, isopropylidene, butylene, butylidene, isobutylidene, amylene, amylidene, isoamylidene, and the like. In other embodiments when E is an alkylene or alkylidene group, it may also consist of two or more alkylene or alkylidene groups connected by a moiety different from alkylene or alkylidene, including, but not limited to, an aromatic linkage; a tertiary nitrogen linkage; an ether linkage; a carbonyl linkage; a silicon-containing linkage, silane, siloxy; or a sulfur-containing linkage including, but not limited to, sulfide, sulfoxide, sulfone, and the like; or a phosphorus-containing linkage including, but not limited to, phosphinyl, phosphonyl, and the like. In other embodiments E may be a cycloaliphatic group including, but not limited to, cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, and the like; a sulfur-containing linkage, including, but not limited to, sulfide, sulfoxide or sulfone; a phosphorus-containing linkage, including, but not limited to, phosphinyl or phosphonyl; an ether linkage; a carbonyl group; a tertiary nitrogen group; or a silicon-containing linkage including, but not limited to, silane or siloxy. R¹ independently at each occurrence comprises a monovalent hydrocarbon group including, but not limited to, alkenyl, allyl, alkyl, aryl, aralkyl, alkaryl, or cycloalkyl. In various embodiments a monovalent hydrocarbon group of R¹ may be halogen-substituted, particularly fluoro- or chloro-substituted, for example as in dichloroalkylidene, particularly gem-dichloroalkylidene. Y¹ independently at each occurrence may be an inorganic atom including, but not limited to, halogen (fluorine, bromine, chlorine, iodine); an inorganic group containing more than one inorganic atom including, but not limited to, nitro; an organic group including, but not limited to, a monovalent hydrocarbon group including, but not limited to, alkenyl, allyl, alkyl, aryl, aralkyl, alkaryl, or cycloalkyl, or an oxy group including, but not limited to, OR² wherein R² is a monovalent hydrocarbon group including, but not limited to, alkyl, aryl, aralkyl, alkaryl, or cycloalkyl; it being only necessary that Y¹ be inert to and unaffected by the reactants and reaction conditions used to prepare the polymer. In some particular embodiments Y¹ comprises a halo group or C₁-C₆ alkyl group. The letter “m” represents any integer from and including zero through the number of replaceable hydrogens on A¹ available for substitution; “p” represents an integer from and including zero through the number of replaceable hydrogens on E available for substitution; “t” represents an integer equal to at least one; “s” represents an integer equal to either zero or one; and “u” represents any integer including zero.

In dihydroxy-substituted aromatic hydrocarbons in which D is represented by formula (II) above, when more than one Y¹ substituent is present, they may be the same or different. The same holds true for the R¹ substituent. Where “s” is zero in formula (II) and “u” is not zero, the aromatic rings are directly joined by a covalent bond with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups. In some particular embodiments the parameters “t”, “s”, and “u” each have the value of one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

In dihydroxy-substituted aliphatic hydrocarbons in which D is represented by formula (II) above, when more than one Y¹ substituent is present, they may be the same or different. The same holds true for the R¹ substituent. The positions of the hydroxyl groups and Y¹ on the aliphatic nuclear residues A¹ can be varied and the groupings can be in vicinal, asymmetrical or symmetrical relationship, where two or more ring carbon atoms of the hydrocarbon residue are substituted with Y¹ and hydroxyl groups. In some particular embodiments the parameters “t”, “s”, and “u” each have the value of one; both A¹ radicals are unsubstituted methylene radicals; and E is a cyclo alkane group such as tricyclodecane.

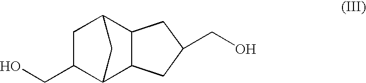

In some embodiments of dihydroxy-substituted aromatic hydrocarbons E may be an unsaturated alkylidene group. Suitable dihydroxy-substituted aromatic hydrocarbons of this type include those of the formula (IV): 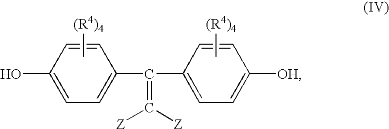
where independently each R⁴ is hydrogen, chlorine, bromine or a C₁₋₃₀ monovalent hydrocarbon or hydrocarbonoxy group, each Z is hydrogen, chlorine or bromine, subject to the provision that at least one Z is chlorine or bromine.

Suitable dihydroxy-substituted aromatic hydrocarbons also include those of the formula (V): 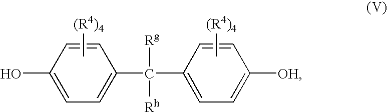
where independently each R4 is as defined hereinbefore, and independently Rg and Rh are hydrogen or a C1-30 hydrocarbon group.

In some embodiments of the present invention, dihydroxy-substituted aromatic hydrocarbons that may be used comprise those disclosed by name or formula (generic or specific) in U.S. Pat. Nos. 2,991,273, 2,999,835, 3,028,365, 3,148,172, 3,153,008, 3,271,367, 3,271,368, and 4,217,438. In other embodiments of the invention, dihydroxy-substituted aromatic hydrocarbons comprise bis(4-hydroxyphenyl)sulfide, bis(4-hydroxyphenyl) ether, bis(4-hydroxyphenyl)sulfone, bis(4-hydroxyphenyl)sulfoxide, 1,4-dihydroxybenzene, 4,4′-oxydiphenol, 2,2-bis(4-hydroxyphenyl)hexafluoropropane, 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene; 2,6-dihydroxy naphthalene; hydroquinone; resorcinol; C1-3 alkyl-substituted resorcinols; methyl resorcinol, catechol, 1,4-dihydroxy-3-methylbenzene; 2,2-bis(4-hydroxyphenyl)butane; 2,2-bis(4-hydroxyphenyl)-2-methylbutane; 1,1-bis(4-hydroxyphenyl)cyclohexane; 4,4′-dihydroxydiphenyl; 2-(3-methyl-4-hydroxyphenyl-2-(4-hydroxyphenyl)propane; 2-(3,5-dimethyl-4-hydroxyphenyl)-2-(4-hydroxyphenyl)propane; 2-(3-methyl-4-hydroxyphenyl)-2-(3,5-dimethyl-4-hydroxyphenyl)propane; bis(3,5-dimethylphenyl-4-hydroxyphenyl)methane; 1,1-bis(3,5-dimethylphenyl-4-hydroxyphenyl)ethane; 2,2-bis(3,5-dimethylphenyl-4-hydroxyphenyl)propane; 2,4-bis(3,5-dimethylphenyl-4-hydroxyphenyl)-2-methylbutane; 3,3-bis(3,5-dimethylphenyl-4-hydroxyphenyl)pentane; 1,1-bis(3,5-dimethylphenyl-4-hydroxyphenyl)cyclopentane; 1,1-bis(3,5-dimethylphenyl-4-hydroxyphenyl)cyclohexane; bis(3,5-dimethyl-4-hydroxyphenyl) sulfoxide, bis(3,5-dimethyl-4-hydroxyphenyl) sulfone and bis(3,5-dimethylphenyl-4-hydroxyphenyl)sulfide. In a particular embodiment the dihydroxy-substituted aromatic hydrocarbon comprises bisphenol A. In another embodiment the polycarbonate is bis(hydroxy ethyl)ether of bisphenol A.

In some embodiments of dihydroxy-substituted aromatic hydrocarbons when E is an alkylene or alkylidene group, said group may be part of one or more fused rings attached to one or more aromatic groups bearing one hydroxy substituent. Suitable dihydroxy-substituted aromatic hydrocarbons of this type include those containing indane structural units such as represented by the formula (VI), which compound is 3-(4-hydroxyphenyl)-1,1,3-trimethylindan-5-ol, and by the formula (VII), which compound is 1-(4-hydroxyphenyl)-1,3,3-trimethylindan-5-ol:

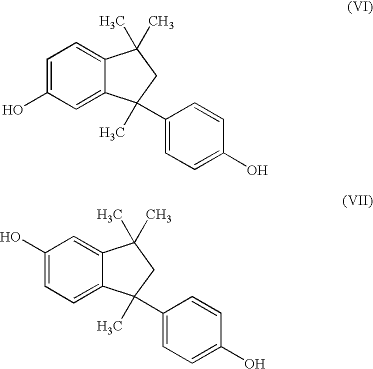

Also included among suitable dihydroxy-substituted aromatic hydrocarbons of the type comprising one or more alkylene or alkylidene groups as part of fused rings are the 2,2,2′,2′-tetrahydro-1,1′-spirobi [1H-indene]diols having formula (VIII): 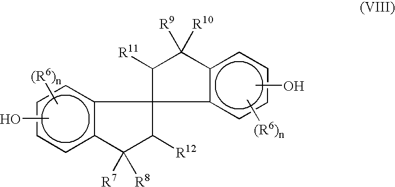
wherein each R6 is independently selected from monovalent hydrocarbon radicals and halogen radicals; each R7, R8, R9, and R10 is independently C1-6 alkyl; each R11 and R12 is independently H or C1-6 alkyl; and each n is independently selected from positive integers having a value of from 0 to 3 inclusive. In a particular embodiment the 2,2,2′,2′-tetrahydro-1,1′-spirobi[ 1H-indene]diol is 2,2,2′,2′-tetrahydro-3,3,3′,3′-tetramethyl-1,1′-spirobi[1H-indene]-6,6′-diol (sometimes known as “SBI”). Mixtures of alkali metal salts derived from mixtures of any of the foregoing (dihydroxy-substituted aromatic hydrocarbons may also be employed.

The term “alkyl” as used in the various embodiments of the present invention is intended to designate both linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. The term “alkyl” also encompasses that alkyl portion of alkoxide groups. In various embodiments normal and branched alkyl radicals are those containing from 1 to about 32 carbon atoms, and include as illustrative non-limiting examples C1-C32 alkyl optionally substituted with one or more groups selected from C1-C32 alkyl, C3-C15 cycloalkyl or aryl; and C3-C15 cycloalkyl optionally substituted with one or more groups selected from C1-C32 alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. In various embodiments aryl radicals used in the various embodiments of the present invention are those substituted or unsubstituted aryl radicals containing from 6 to 18 ring carbon atoms. Some illustrative non-limiting examples of these aryl radicals include C6-C15 aryl optionally substituted with one or more groups selected from C1-C32 alkyl, C3-C15 cycloalkyl or aryl. Some particular illustrative examples of aryl radicals comprise substituted or unsubstituted phenyl, biphenyl, toluyl and naphthyl.

Mixtures comprising two or more hydroxy-substituted hydrocarbons may also be employed. In some particular embodiments mixtures of at least two monohydroxy-substituted alkyl hydrocarbons, or mixtures of at least one monohydroxy-substituted alkyl hydrocarbon and at least one dihydroxy-substituted alkyl hydrocarbon, or mixtures of at least two dihydroxy-substituted alkyl hydrocarbons, or mixtures of at least two monohydroxy-substituted aromatic hydrocarbons, or mixtures of at least two dihydroxy-substituted aromatic hydrocarbons, or mixtures of at least one monohydroxy-substituted aromatic hydrocarbon and at least one dihydroxy-substituted aromatic hydrocarbon, or mixtures of at least one monohydroxy-substituted alkyl hydrocarbon and at least one dihydroxy-substituted aromatic hydrocarbon may be employed.

In yet another, the polycarbonate resin is a linear polycarbonate resin that is derived from bisphenol A and phosgene. In an alternative embodiment, the polycarbonate resin is a blend of two or more polycarbonate resins. In yet another embodiment the polycarbonate resin is derived from a mixture of aliphatic and aromatic polycarbonates. In one embodiment the polycarbonate resin of the present invention is derived from bisphenol A and tricyclodecyl methanol based polycarbonate.

The aromatic polycarbonate may be prepared in the melt, in solution, or by interfacial polymerization techniques well known in the art. For example, the aromatic polycarbonates can be made by reacting bisphenol-A with phosgene, dibutyl carbonate or diphenyl carbonate. Such aromatic polycarbonates are also commercially available. In one embodiment, the aromatic polycarbonate resins are commercially available from General Electric Company, e.g., LEXAN™ bisphenol A-type polycarbonate resins.

The preferred polycarbonates are preferably high molecular weight aromatic carbonate polymers have an intrinsic viscosity (as measured in methylene chloride at 25° C.) ranging from about 0.30 to about 1.00 deciliters per gram. Polycarbonates may be branched or unbranched and generally will have a weight average molecular weight of from about 10,000 to about 200,000, preferably from about 20,000 to about 100,000 as measured by gel permeation chromatography. It is contemplated that the polycarbonate may have various known end groups.

In one embodiment of the present invention the polycarbonates could be a mixture of aromatic and aliphatic polycarbonates. In another embodiment of the present invention the polycarbonate could be a bisphenol A modified polycarbonate wherein the bisphenol is modified with a diol. The diol can be selected from aliphatic or aromatic diols. In another embodiment the diol may be straight chain, branched, or cycloaliphatic alkane diols and may contain from 2 to 12 carbon atoms. Examples of such diols include but are not limited to ethylene glycol; propylene glycol, i.e., 1, 2- and 1,3-propylene glycol; 2,2-dimethyl-1,3-propane diol; 2-ethyl, 2-methyl, 1,3-propane diol; 1,3- and 1,5-pentane pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. Preferably, glycol or chemical equivalent thereof and particularly ethylene glycol or its chemical equivalents are used as the diol component. Chemical equivalents to the diols include esters, such as dialkylesters, diaryl esters, and the like.

In one embodiment the optically clear thermoplastic composition comprises polyesters. Methods for making polyester resins and the use of polyester resins in thermoplastic molding compositions are known in the art. Conventional polycondensation procedures are described in the following, see, generally, U.S. Pat. Nos. 2,465,319, 5,367,011 and 5,411,999, the respective disclosures of which are each incorporated herein by reference.

Typically polyester resins include crystalline polyester resins such as polyester resins derived from an aliphatic or cycloaliphatic diol, or mixtures thereof, containing from 2 to about 10 carbon atoms and at least one aromatic dicarboxylic acid. Preferred polyesters are derived from an aliphatic diol and an aromatic dicarboxylic acid and have repeating units according to structural formula (IX) 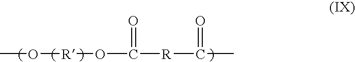
wherein, R′ is an alkyl radical compromising a dehydroxylated residue derived from an aliphatic or cycloaliphatic diol, or mixtures thereof, containing from 2 to about 20 carbon atoms. R is an aryl radical comprising a decarboxylated residue derived from an aromatic dicarboxylic acid. In one embodiment of the present invention the polyester could be an aliphatic polyester where at least one of R′ or R is a cycloalkyl containing radical. The polyester is a condensation product where R′ is the residue of an aryl, alkane or cycloalkane containing diol having 6 to 20 carbon atoms or chemical equivalent thereof, and R is the decarboxylated residue derived from an aryl, aliphatic or cycloalkane containing diacid of 6 to 20 carbon atoms or chemical equivalent thereof. The polyester resins are typically obtained through the condensation or ester interchange polymerization of the diol or diol equivalent component with the diacid or diacid chemical equivalent component.

The diacids meant to include carboxylic acids having two carboxyl groups each useful in the preparation of the polyester resins of the present invention are preferably aliphatic, aromatic, cycloaliphatic. Examples of diacids are cyclo or bicyclo aliphatic acids, for example, decahydro naphthalene dicarboxylic acids, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, alkyl esters, e.g., dialkyl esters, diaryl esters, anhydrides, salts, acid chlorides, acid bromides, and the like. Examples of aromatic dicarboxylic acids from which the decarboxylated residue R may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′- bisbenzoic acid and mixtures thereof, as well as acids contain fused rings such as, e.g., 1,4- or 1,5-naphthalene dicarboxylic acids. In a preferred embodiment, the dicarboxylic acid precursor of residue R is terephthalic acid or, alternatively, a mixture of terephthalic and isophthalic acids.

Some of the diols useful in the preparation of the polyester resins of the present invention are straight chain, branched, or cycloaliphatic alkane diols and may contain from 2 to 12 carbon atoms. Examples of such diols include but are not limited to ethylene glycol; propylene glycol, i.e., 1,2- and 1,3-propylene glycol; 2,2-dimethyl-1,3- propane diol; 2-ethyl, 2- methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. Preferably, a cycloaliphatic diol or chemical equivalent thereof and particularly 1,4-cyclohexane dimethanol or its chemical equivalents are used as the diol component. Chemical equivalents to the diols include esters, such as dialkylesters, diaryl esters, and the like.

Typically the polyester resin may comprise one or more resins selected from linear polyester resins, branched polyester resins and copolymeric polyester resins. Suitable linear polyester resins include, e.g., poly(alkylene phthalate)s such as, e.g., poly(ethylene terephthalate) (“PET”), poly(butylene terephthalate) (“PBT”), poly(propylene terephthalate) (“PPT”), poly(cycloalkylene phthalate)s such as, e.g., poly(cyclohexanedimethanol terephthalate) (“PCT”), poly(alkylene naphthalate)s such as, e.g., poly(butylene-2,6-naphthalate) (“PBN”) and poly(ethylene-2,6-naphthalate) (“PEN”), poly(alkylene dicarboxylate)s such as, e.g., poly(butylene dicarboxylate).

In one embodiment of the present invention the polyester is an aliphatic polyester where at least one of R′ or R is a cycloalkyl containing radical. In one embodiment at least one R′ or R is cycloaliphatic. Preferred polyesters of the invention will have both R′ and R cycloaliphatic. In one embodiment the present cycloaliphatic polyesters are condensation products of aliphatic diacids, or chemical equivalents and aliphatic diols, or chemical equivalents. The present cycloaliphatic polyesters may be formed from mixtures of aliphatic diacids and aliphatic diols but must contain at least 50 mol % of cyclic diacid and/or cyclic diol components, the remainder, if any, being linear aliphatic diacids and/or diols. The cyclic components are necessary to impart good rigidity to the polyester and to allow the formation of transparent blends due to favorable interaction with the polycarbonate resin.

R′ and R are preferably cycloalkyl radicals independently selected from the following formula:

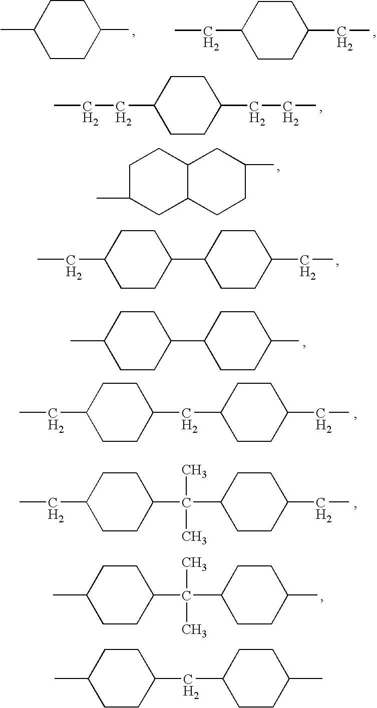

The preferred cycloaliphatic radical R is derived from the 1,4-cyclohexyl diacids and most preferably greater than 70 mol % thereof in the form of the trans isomer. The preferred cycloaliphatic radical is derived from the 1,4-cyclohexyl primary diols such as 1,4-cyclohexyl dimethanol, most preferably more than 70 mol % thereof in the form of the trans isomer.

Typically, in the hydrogenation, two isomers are obtained in which the carboxylic acid groups are in cis- or trans-positions. The cis- and trans-isomers can be separated by crystallization with or without a solvent, for example, n-heptane, or by distillation. The cis-isomer tends to blend better; however, the trans-isomer has higher melting and crystallization temperatures and may be preferred. Mixtures of the cis- and trans-isomers are useful herein as well. When the mixture of isomers or more than one diacid or diol is used, a copolyester or a mixture of two polyesters may be used as the present cycloaliphatic polyester resin.

A preferred cycloaliphatic polyester is poly(cyclohexane-1,4-dimethylene cyclohexane-1,4-dicarboxylate) also referred to as poly(l, 4-cyclohexane-dimethanol 1,4-dicarboxylate) (PCCD) which has recurring units of formula X:

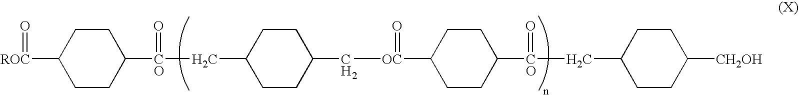

With reference to the previously set forth general formula, for PCCD, R₃ is derived from 1,4 cyclohexane dimethanol; and R₄ is a cyclohexane ring derived from cyclohexanedicarboxylate or a chemical equivalent thereof. The favored PCCD has a cis/trans formula. In one embodiment R is an alkyl from 1 to 6 carbon atoms or residual endgroups derived from either monomer, and n is greater than about 70. The polyester is derived from the transesterification reaction of a starting DMCD and a starting CHDM. The trans-cis ratio of repeating units derived from DMCD is preferably greater than about 8 to 1, and the trans-cis ratio of repeating units derived from CHDM is preferable greater than about 1 to 1. The polyester resin typically a viscosity of about 2500 poise and a melting temperature greater than 216° C. degrees Centigrade, and an acid number less than about 10, preferably less than about 6 meq/kg.

The linear PCCD polyester is prepared by the condensation reaction of CHDM and DMCD in the presence of a catalyst wherein the starting DMCD has a trans-cis ratio greater than the equilibrium trans-cis ratio. The resulting prepared PCCD polyester has a trans-cis ratio of repeating polymer units derived from the respective starting DMCD which has a trans-cis ratio substantially equal to the respective starting trans-cis ratio for enhancing the crystallinity of the resulting PCCD.

The starting DMCD typically has a trans-cis ratio greater than about 6 to 1, preferably greater than 9 to 1, and even more preferably greater than 19 to 1. In the resulting PCCD, it is preferable that less than about 10 percent the starting trans DMCD, and more preferable that less than about 5 percent ol the starting trans DMCD be converted to the cis isomer during the reaction of CHDM and DMCD to produce PCCD. The trans:cis ratio of the CHDM is preferable greater than 1 to 1, and more preferably greater than about 2 to 1.

The resulting linear PCCD polymer is characterized by the absence of branching. During the reaction process, branching may be induced by the addition of polyglycol and such branching agents as trimellitic acid or anhydride, trimesic acid, trimethyiolethane, trimethylolpropane, or a trimer acid. The use of such branching agents is not desirable according to the present invention.

Preferably the amount of catalyst present is less than about 200 ppm. Typically, catalyst may be present in a range from about 20 to about 300 ppm. The most preferred materials are blends where the polyester has both cycloaliphatic diacid and cycloaliphatic diol components specifically polycyclohexane dimethanol cyclohexyl dicarboxylate (PCCD).

In one embodiment the above polyesters with from about 1 to about 50% by weight, of units derived from polymeric aliphatic acids and/or polymeric aliphatic polyols to form copolyesters. The aliphatic polyols include glycols, such as poly(ethylene glycol) or poly(butylene glycol). In another embodiment suitable copolymeric polyester resins include, e.g., polyesteramide copolymers, cyclohexanedimethanol-terephthalic acid-isophthalic acid copolymers and cyclohexanedimethanol-terephthalic acid-ethylene glycol (“PCTG”) copolymers. The polyester component may be prepared by procedures well known to those skilled in this art, such as by condensation reactions. The condensation reaction may be facilitated by the use of a catalyst, with the choice of catalyst being determined by the nature of the reactants. The various catalysts for use herein are very well known in the art and are too numerous to mention individually herein. Generally, however, when an alkyl ester of the dicarboxylic acid compound is employed, an ester interchange type of catalyst is preferred, such as Ti(OC₄H₉)₆ in n-butanol in a suitable amount, typically about 50 ppm to about 200 ppm of titanium based upon the final product.

The preferred polyesters are preferably low molecular weight polyester polymers have an intrinsic viscosity (as measured in methylene chloride at 25° C.) ranging from about 0.1 to about 0.5 deciliters per gram. Polyesters branched or unbranched and generally will have a weight average molecular weight of from about 5,000 to about 30,000, preferably from about 8,000 to about 20,000 as measured by viscosity measurements in Phenol/tetrachloroethane (60:40, volume/volume ratio) solvent mixture. It is contemplated that the polyesters have various known end groups.

The range of composition of the blends of the present invention is from about 10 to 90 weight percent of the polycarbonate component, 90 to about 10 percent by weight of the polyester component. In one embodiment, the composition comprises about 30-70 weight percent polycarbonate and 70-30 weight percent of the polyester component. In one embodiment of the present invention the polycarbonate is a mixture of an aromatic polycarbonate and an aliphatic polycarbonate in the ratio of about 5 to about 25 weight percent of the polycarbonate component.

In one embodiment the synthesis of polycarbonate polyester blends may optionally have the presence of a catalyst to facilitate the formation of the blend. Generally, the transesterification catalyst (or mixture of catalysts) is added in very small amount (ppm level) during the melt mixing of polycarbonate and polyesters to promote the ester-carbonate exchange reactions. The catalyst employed are compounds of alkaline earth metal oxides such as magnesium oxides, calcium oxide, barium oxide and zinc oxide; alkali and alkaline earth metal salts; a Lewis catalyst such as tin or titanium compounds; a nitrogen-containing basic compound and the like. However, the presence of excess catalyst leads to yellowing or color formation and the blends therefore become less transparent. Quenchers for example compounds like phosphoric acids, are typically added to the blends during the extrusion process to quench the excess catalyst and render the blends transparent. In one embodiment of the present invention additional catalyst or quencher are not added while the thermoplastic resin is being synthesized. In another embodiment of the present invention, the residual catalyst that is present in the polyester component is activated to enhance the ester-carbonate interchange reactions in reactive blending.

The composition of the present invention may include additional components which do not interfere with the previously mentioned desirable properties but enhance other favorable properties such as anti-oxidants, flame retardants, reinforcing materials, colorants, mold release agents, fillers, nucleating agents, UV light stabilizers, heat stabilizers, lubricants, and the like. Additionally, additives such as antioxidants, minerals such as talc, clay, mica, barite, wollastonite and other stabilizers including but not limited to UV stabilizers, such as benzotriazole, supplemental reinforcing fillers such as flaked or milled glass, and the like, flame retardants, pigments or combinations thereof may be added to the compositions of the present invention. In one embodiment of the present invention the high flow thermoplastic resin may contain mold release agents for examples of including but not limited to pentaerythritol tetrastearate, stearyl stearate, beeswax, montan wax, and paraffin wax. Combinations of any of the foregoing additives may be used. Such additives may be mixed at a suitable time during the mixing of the components for forming the composition.

The composition of the present invention may optionally include additional components which do not interfere with the previously mentioned desirable properties but enhance other favorable properties such as anti-oxidants, flame retardants, reinforcing materials, colorants, mold release agents, fillers, nucleating agents, UV light and heat stabilizers, lubricants, and the like. Additionally, additives such as antioxidants, minerals such as talc, clay, mica, barite, wollastonite and other stabilizers including but not limited to UV stabilizers, such as benzotriazole, supplemental reinforcing fillers such as flaked or milled glass, and the like, flame retardants, pigments or combinations thereof may be added to the compositions of the present invention.

Flame-retardant additives are desirably present in an amount at least sufficient to reduce the flammability of the polyester resin, preferably to a UL94 V-0 rating. The amount will vary with the nature of the resin and with the efficiency of the additive. In general, however, the amount of additive will be from 2 to 30 percent by weight based on the weight of resin. A preferred range will be from about 15 to 20 percent.

Typically halogenated aromatic flame-retardants include tetrabromobisphenol A polycarbonate oligomer, polybromophenyl ether, brominated polystyrene, brominated BPA polyepoxide, brominated imides, brominated polycarbonate, poly (haloaryl acrylate), poly (haloaryl methacrylate), or mixtures thereof. Examples of other suitable flame retardants are brominated polystyrenes such as polydibromostyrene and polytribromostyrene, decabromobiphenyl ethane, tetrabromobiphenyl, brominated alpha, omega-alkylene-bis-phthalimides, e.g. N,N′-ethylene-bis-tetrabromophthalimide, oligomeric brominated carbonates, especially carbonates derived from tetrabromobisphenol A, which, if desired, are end-capped with phenoxy radicals, or with brominated phenoxy radicals, or brominated epoxy resins.

The flame retardants are typically used with a synergist, particularly inorganic antimony compounds. Such compounds are widely available or can be made in known ways. Typical, inorganic synergist compounds include Sb₂O₅, SbS₃, sodium antimonate and the like. Especially preferred is antimony trioxide (Sb₂O₃). Synergists such as antimony oxides, are typically used at about 0.5 to 15 by weight based on the weight percent of resin in the final composition. Also, the final composition may contain polytetrafluoroethylene (PTFE) type resins or copolymers used to reduce dripping in flame retardant thermoplastics.

Other additional ingredients may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isob utylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4octadecyloxyphenol; iii) hydroxylated thiodiphenyl ethers; iv) alkylidene-bisphenols; v) benzyl compounds, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl) propionic acid with mono-or polyhydric alcohols, e.g., with methanol, diethylene glycol, octadecanol, triethylene glycol, 1,6-hexanediol, pentaerythritol, neopentyl glycol, tris(hydroxyethyl) isocyanurate, thiodiethylene glycol, N,N-bis(hydroxyethyl) oxalic acid diamide. Typical, UV absorbers and light stabilizers include i) 2-(2′-hydroxyphenyl)-benzotriazoles, for example, the 5′methyl-,3′5′-di-tert-butyl-,5′-tert-butyl-,5′(1,1,3,3-tetramethylbutyl)-,5-chloro-3′,5′-di-tert-butyl-,5-chloro-3′tert-butyl-5′methyl-,3′sec-butyl-5′tert-butyl-,4′-octoxy,3′,5′-ditert-amyl-3′,5′-bis-(alpha, alpha-dimethylbenzyl)-derivatives; ii) 2.2 2-Hydroxy-benzophenones, for example, the 4-hydroxy-4-methoxy-,4-octoxy,4-decloxy-,4-dodecyloxy-,4-benzyloxy,4,2′,4′-trihydroxy-and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis-(4-tert-butylbenzoyl)-resorcinol, benzoylresorcinol, 2,4-di-tert-butyl-phenyl-3,5-di-tert-butyl-4-hydroxybenzoate and hexadecyl-3,5-di-tert-butyl-4-hydroxybenzoate. Phosphites and phosphonites stabilizers, for example, include triphenyl phosphite, diphenylalkyl phosphites, phenyldialkyl phosphites, tris(nonyl-phenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite tristearyl sorbitol triphosphite, and tetrakis(2,4-di-tert-butylphenyl)4,4′-biphenylene diphosphonite.

Dyes or pigments may be used to give a background coloration. Dyes are typically organic materials that are soluble in the resin matrix while pigments may be organic complexes or even inorganic compounds or complexes which are typically insoluble in the resin matrix. These organic dyes and pigments include the following classes and examples: furnace carbon black, titanium oxide, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

The range of composition of the thermoplastic resin of the present invention is from about 10 to 90 weight percent of the polycarbonate component, 90 to about 10 percent by weight of the polyester component. In one embodiment, the composition comprises about 30-75 weight percent polycarbonate and 75-30 weight percent of the polyester component.

The method of blending can be carried out by conventional techniques. The production of the compositions may utilize any of the blending operations known for the blending of thermoplastics, for example blending in a kneading machine such as a Banbury mixer or an extruder. To prepare the resin composition, the components may be mixed by any known methods. Typically, there are two distinct mixing steps: a premixing step and a melt mixing step. In the premixing step, the dry ingredients are mixed together. The premixing step is typically performed using a tumbler mixer or ribbon blender. However, if desired, the premix may be manufactured using a high shear mixer such as a Henschel mixer or similar high intensity device. The premixing step is typically followed by a melt mixing step in which the premix is melted and mixed again as a melt. Alternatively, the premixing step may be omitted, and raw materials may be added directly into the feed section of a melt mixing device, preferably via multiple feeding systems. In the melt mixing step, the ingredients are typically melt kneaded in a single screw or twin screw extruder, a Banbury mixer, a two roll mill, or similar device.

In one embodiment of the present invention the thermoplastic composition could be prepared by solution method solution method. The Solution method involves dissolving all the ingredients in a common solvent (or) a mixture of solvents and either precipitation in a non-solvent or evaporating the solvent either at room temperature or a higher temperature. In one embodiment, the polycarbonates and the polyester can be mixed with a relatively volatile solvent, preferably an organic solvent, which is substantially inert towards the polymer, and will not attack and adversely affect the polymer. Some suitable organic solvents include ethylene glycol diacetate, butoxyethanol, methoxypropanol, the lower alkanols, chloroform, acetone, methylene chloride, carbon tetrachloride, tetrahydrofuran, and the like. In one embodiment of the present invention the non solvent is at least one selected from the group consisting of mono alcohols such as ethanol, methanol, isopropanol, butanols and lower alcohols with C1 to about C12 carbon atoms. In one embodiment the solvent is chloroform. In another embodiment the non-solvent is methanol.

The glass transition temperature of the preferred blend is from about 60° C. to about 150° C., more preferably from 85° C. to about 125° C.

The composition of the present invention can be molded into useful articles by a variety of means by many different processes to provide useful molded products such as injection, extrusion, rotation, foam molding calender molding and blow molding and thernoforming, compaction, melt spinning form articles. The thermoplastic composition of the present invention has additional properties of good mechanical properties, color stability, oxidation resistance, good flame retardancy, good processability, i.e. short molding cycle times, good flow, and good insulation properties. The articles made from the composition of the present invention may be used widely in house ware objects such as food containers and bowls, home appliances, as well as films, electrical connectors, electrical devices, computers, building and construction, outdoor equipment, trucks and automobiles

### EXAMPLES

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. While only certain features of the invention have been illustrated and described herein, many modifications and changes will occur to those skilled in the art. Accordingly, these examples are not intended to limit the invention, as defined in the appended claims, in any manner.

In the following examples values for glass transition temperatures (Tg) were determined by differential scanning calorimetry (DSC) at a heating rate of 20° C. per minute. Weight average molecular weights were measured from viscosity measurements in Phenol/Tetrachloroethane 60/40 volume by volume ratio of the solvent mixture. Yellow index or YI was measured on a Gardner Colorimeter model XL-835. The percentage transmission and haze were determined in accordance with test method ASTM D-1003. Melt volume rate was measured as per ISO Standard 1133, 265° C., 240 seconds, 2.16 Kg, and 0.0825 inch orifice. The heat distortion temperature (also known as HDT) test were performed by placing HDT samples edgewise, at load of 1.8 MPa and heating rate of 120° C./hr (degree celsius/hr). The inherent viscosity ranged from 0.19 to 0.24 dL/g and was measured using phenol and tetrachloroethane mixture at 25° C.

### Example 1-3

### Preparation of Low Molecular Weight PCCD.

The low molecular weight PCCD was synthesized by polymerizing 1,4-cyxlohexane dimethanol with 1,4-cyclohexane dicarboxylate. The polymerization reaction was carried out in a cylindrical glass reactor equipped with side arm, a mechanical stirrer driven by an overhead stirring motor and a small side arm with stopcock. The side ann is used to purge nitrogen gas as well as for applying vacuum. The reactor was evacuated and purged with Nitrogen for three times to remove the traces of oxygen. The reactor was purged with nitrogen and brought to atmospheric pressure. The monomers were taken in the reactor and the contents were heated till a clear melt was obtained. The stirring was continued constantly at 100 rotations per minute under nitrogen. Through the small side arm 400 ppm of titanium (IV) isopropoxide was added as a catalyst and the ester interchange reaction proceeded with the distillation of methanol through the side arm. The temperature of the melt was increased to 250° C. and stirred for 1 hour under nitrogen. The polycondensation was conducted by reducing the pressure in the reactor in stepwise from 900 mm of mercury to 700, 500, 300, 100, 50, 25 10 mbar at 250° C. The pressure inside the reactor was to taken to atmospheric pressure by purging nitrogen. The polymers were collected by nitrogen gas pressure by breaking the nipple at the bottom of the reactor and viscosity was determined. The inherent viscosity and molecular weight obtained are given in Table 1.

### Example 4

Low molecular weight PCCD was also be prepared by degrading high molecular weight PCCD from Eastman Chemical Company under the name PCCD-4000 in an extruder i.e. a 25 mm ZSK twin screw extruder in presence of a base such as sodium stearate at a temperature of about 260° C.

TABLE 1

| | Inherent | |
|---|---|---|
| PCCD Sample | Viscosity | Mw |
| Ex. 1 | 0.19 | 12,800 |
| Ex. 2 | 0.21 | 14,000 |
| Ex. 3 | 0.24 | 17,400 |

### Example 5-6

### Preparation of bis(4-hydroxy-1-ethoxy) phenyl dimethyl methane-polycarbonate (Dianol 220-PC) and tricyclodecyl methyl-polycarbonate (TCD-PC)

The Dianol-220 was obtained from Seppic, France. The TCD-diol is commercially available from Celanese Corp. The polycarbonates were prepared by melt polycondensation method. The polymerization was carried out using sodium hydroxide and tetramehtyl ammonium hydroxide as catalyst and the polymerization was carried out up to 270° C. The polymers obtained are clear and transparent. The Tg of Dianol PC (Ex. 5) is 62° C. and of TCD PC (Ex. 6) is 65° C.

### Examples 7-10

### Preparation of Thermoplastic Composition

General Electric Company as Lexan® polycarbonate resin 105 with a PCCD from Eastman Chemical Company under the name PCCD 2000 were employed. The PCCD was mixed with polycarbonate in a ratio of about 70 weight percent to about 30 weight percent respectively. The mixture was then dissolved in chloroform at room temperature. The solvent was allowed to evaporate at room temperature. The films of the composition obtained were semitransparent. The bisphenol A polycarbonate with low molecular weight PCCD of Ex. 1-Ex. 3 compositions in the ratio of 70 weight percent to 30 weight percent respectively was synthesized similarly. All the compositions over the range of components tested exhibited a single Tg indicating good miscibility. The Tg data obtained is given in Table 2.

### Examples 11-14

### Preparation of Thermoplastic Composition

General Electric Company as Lexan® polycarbonate resin 105 was employed with a PCCD from Eastman Chemical Company under the name PCCD-2000 were employed. The thermoplastic composition of BPA-PC, Dianol220 PC and TCD PC were mixed with PCCD in different (60/10/30, 50/20/30) weight proportions. The mixture was then dissolved in chloroform at room temperature. The solvent was allowed to evaporate at room temperature. The films of the composition obtained were semitransparent. All the blends over the range of compositions tested exhibited a single Tg indicating good miscibility. The Tg data obtained is given in Table 2.

TABLE 2

| | | Composition | |
|---|---|---|---|
| | | Polycarbonate:PCCD | |
| | Blend | (Weight %) | T_{g} (° C.) |
| Ex. 6 | BPA-PC - PCCD | 70:30 | 121 |
| Ex. 7 | BPA-PC - Ex 1. | 70:30 | 85 |
| Ex. 8 | BPA-PC - Ex. 2 | 70:30 | 85 |
| Ex. 9 | BPA-PC - Ex. 3 | 70:30 | 115 |
| Ex. 10 | BPA-PC - Ex. 4 - PCCD | 60:10:30 | 102 |
| Ex. 11 | BPA-PC - Ex. 4 - PCCD | 50:20:30 | 82 |
| Ex. 12 | BPA-PC - Ex. 5 - PCCD | 60:10:30 | 85 |
| Ex. 13 | BPA-PC - Ex. 5 - PCCD | 50:20:30 | 95 |

### Examples 15-16

The polycarbonate was taken in a reactor along with polyester which was PCCD that was degraded as in Ex. 4 and the compounding was carried out at total feed rate of 15 kg/hr using ZSK25 twin-screw extruder. The screw was rotated at a speed of 300 rotations per minute. The mixture was dried in an oven at 90° C. for 4 hours and then injection molded. The optical properties, Flow (MVR) and HDT are reported in Table 3.

### Example 17

The polycarbonate was taken in a reactor along with polyester which was PCCD obtained from Eastman Chemical Company and the compounding was carried out at total feed rate of 15 kg/hr using ZSK25 twin-screw extruder. The screw was rotated at a speed of 300 rotations per minute. The mixture was dried in an oven at 90° C. for 4 hours and then injection molded. The optical properties, Flow (MVR) and HDT are reported in Table 3.

TABLE 3

| | | | Transmittance | Haze | | |
|---|---|---|---|---|---|---|
| | PCCD | YI | (%) | (%) | MVR | HDT |
| Ex. 15 | PCCD Degraded | 4.39 | 90.77 | 1.61 | 21 | 100.6 |
| Ex. 16 | PCCD Degraded | 5.08 | 89.85 | 1.63 | 21.3 | 98.6 |
| Ex. 17 | PCCD (4000) | 5.18 | 88.17 | 3.59 | 19 | 101.5 |

These data show that polycarbonate polyester blends of the present invention have better flow, beneficial optical properties and good stability characteristics.

While the invention has been illustrated and described il typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A high flow miscible thermoplastic resin blend composition comprising:
a substituted or unsubstituted polycarbonate; and
a substituted or unsubstituted aliphatic polyester, said polyester having an intrinsic viscosity of 0.1 to 0.5 deciliters per gram.

2. The composition of claim 1, wherein said polycarbonate comprises repeating units of the formula: 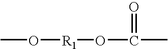
wherein R₁ is a divalent aliphatic or aromatic radical derived from a dihydroxy compound of the formula HO—D—OH, wherein D has the structure of formula: 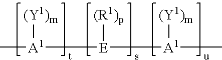
wherein A¹ represents an aromatic group or an aliphatic group; E comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl, and phosphonyl;
R¹ independently at each occurrence comprises a mono-valent hydrocarbon group, alkenyl, allyl, alkyl, aryl, aralkyl, alkaryl, or cycloalkyl;
Y¹ independently at each occurrence is selected from the group consisting of an inorganic atom, a halogen; an inorganic group, a nitro group; an organic group, a monovalent hydrocarbon group, alkenyl, allyl, alkyl, aryl, aralkyl, alkaryl, cycloalkyl, and an alkoxy group;
the letter “m” represents any integer from and including zero through the number of replaceable hydrogens on A¹ available for substitution;
the letter “p” represents an integer from and including zero through the number of replaceable hydrogens on E available for substitution;
the letter “t” represents an integer equal to at least one;
the letter “s” represents an integer equal to either zero or one; and
“u” represents any integer including zero.

3. The composition of claim 2, wherein the dihydroxyaromatic compound from which D is derived is bisphenol A.

4. The composition of claim 2, wherein the dihydroxyaromatic compound from which D is derived is a modified bisphenol A.

5. The composition of claim 4, wherein the bisphenol A is modified with diol wherein said diol is at least one selected from the group consisting of a alkylydiene diols, alkane diols, straight chain, branched, or cycloaliphatic alkane diols containing at least about 2 to 20 carbon atoms.

6. The composition of claim 5, wherein the diol is selected from a group consisting of ethylene glycol; propylene glycol, pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures thereof.

7. The composition of claim 1, wherein the polycarbonate comprises a mixture of aromatic and aliphatic polycarbonates.

8. The composition of claim 7, wherein said polycarbonate comprises a mixture of bisphenol A polycarbonate and tricyclodecane methanol polycarbonate.

9. The composition of claim 1, wherein the polyester is selected from the group consisting of poly(ethylene terephthalate), poly(butylene terephthalate), poly(propylene terephthalate), poly(cyclohexanedimethanol terephthalate), poly(cyclohexanedimethanol-terephthalic acid-ethylene glycol), poly(butylene-2,6-naphthalate), poly(ethylene-2,6-naphthalate), poly(butylene dicarboxylate) and combinations thereof.

10. (canceled)

11. The composition of claim 1, wherein the molecular weight of the polyester is in a range of between about 8,000 to about 20,000.

12. The composition of claim 1, wherein said thermoplastic resin composition comprises polyester and polycarbonate in a range of about 10 to 90 percent by weight of polyester and 90 to 10 percent by weight of polycarbonate.

13. The composition of claim 1, wherein said thermoplastic resin composition comprises polyester and polycarbonate in a range of about 30 to 70 percent by weight of polyester and 70 to 30 percent by weight of polycarbonate.

14. The composition of claim 1, wherein said thermoplastic resin composition has a yellowness index of less than about 10.

15. The composition of claim 1, wherein said thermoplastic resin composition has a glass transition temperature of between about 85° C. and about 125° C.

16. An article comprising the composition of claim 1.

17. A high flow miscible thermoplastic resin blend composition comprising:
a substituted or unsubstituted polycarbonate; and
a substituted or unsubstituted low molecular weight aliphatic polyester having a weight average molecular weight of from 5,000 to 30,000 g/mol.

18. The composition of claim 17, wherein said polycarbonate is a bisphenol A polycarbonate.

19. The composition of claim 17, wherein said polyester is selected from the group consisting of poly(ethylene terephthalate), poly(butylene terephthalate), poly(propylene terephthalate), poly(cyclohexanedimethanol terephthalate), poly(cyclohexanedimethanol-terephthalic acid-ethylene glycol), poly(butylene-2,6-naphthalate), poly(ethylene-2,6-naphthalate), poly(butylene dicarboxylate) and combinations thereof.

20. The composition of claim 17, wherein said polyester has a weight average molecular weight in a range of between about 8,000 and about 20,000.

21. The composition of claim 17, wherein said thermoplastic resin composition comprises polyester and polycarbonate in a range of about 10 to about 90 percent by weight of polyester and about 90 to about 10 percent by weight of polycarbonate.

22. The composition of claim 17, wherein said thermoplastic resin composition has a yellowness index of less than about 10.

23. The composition of claim 17, wherein said thermoplastic resin composition has a glass transition temperature of between about 85° C. and about 125° C.

24. An article comprising the composition of claim 17.

25-33. (canceled)

34. The composition of claim 1, wherein the composition has a Tg of from 85 to 115° C.

35. The composition of claim 1, wherein the polyester is a thermally degraded PCCD.

36. The composition of claim 17, wherein the composition has a Tg of from 85 to 115° C.

37. The composition of claim 17, wherein the polyester is a thermally degraded PCCD.

38. A high flow miscible thermoplastic resin blend composition comprising:
a substituted or unsubstituted polycarbonate; and
a substituted or unsubstituted aliphatic polyester, wherein the polycarbonate comprises a mixture of bisphenol A polycarbonate and tricyclodecane methanol polycarbonate.

39. The composition of claim 38, further comprising bis(4-hydroxy-1-ethoxy) phenyl dimethyl methane polycarbonate.

40. The composition of claim 39, wherein the composition has a Tg of 82 to 102° C.

41. The composition of claim 38, wherein the composition has a Tg of 82 to 102° C.

42. A high flow miscible thermoplastic resin blend composition comprising:
a substituted or unsubstituted polycarbonate; and
a substituted or unsubstituted aliphatic polyester, wherein the polycarbonate comprises a polycarbonate having a Tg of from 62° C. to 65° C.

43. The composition of claim 42, wherein the composition has a Tg of 82 to 102° C.
